(19) United States
(12) Patent Application Publication
(10) Pub. No.: US 2023/0245222 A1
(43) Pub. Date: Aug. 3, 2023

(54) AUGMENTED REALITY PRODUCT PRESENTATION SYSTEM

(71) Applicant: SPEED 3D Inc., Taipei City (TW)

(72) Inventors: Li-Chuan Chiu, Taipei City (TW); Jui-Chun Chung, Taipei City (TW); Yi-Ping Cheng, Taipei City (TW)

(73) Assignee: SPEED 3D Inc., Taipei City (TW)

(21) Appl. No.: 17/881,596

(22) Filed: Aug. 4, 2022

(30) Foreign Application Priority Data
Jan. 27, 2022 (TW) 111103605

(51) Int. Cl. G06Q 30/06; G06F 16/955

(52) U.S. Cl. CPC G06Q 30/0643; G06F 16/955

(57) ABSTRACT

An AR product presentation system includes a network server, a product information editing module, an AR 3D image generating module, a data storage module and a data processing module. The product information editing module generates a product browsing webpage. The AR 3D image generating module generates an AR 3D product image by integrating the view angle plane images of a product with each other. The data storage module saves the product browsing webpage and the AR 3D product image. The data processing module integrates the product browsing webpage with the AR 3D product image to generate a product link information. The mobile device of a consumer receives the product link information and the consumer clicks which to connect to the product browsing webpage and execute the AR 3D product image. Then, the AR 3D product image can be integrated with a target object displayed on the mobile device.

### BACKGROUND OF THE INVENTION

### 1. Field of the Invention

The present invention relates to an augmented reality (AR) product presentation system, in particular to an AR product presentation system capable of automatically integrating the view angle plane images of a product with each other to generate an AR 3D image for a consumer to browse the product via a hyperlink and experience wearing the product based on AR via the internet.

### 2. Description of the Prior Art

With the rise of the Internet, more and more services are presented on users’ web browsers through HyperText Markup Language (HTML). In order to meet the various needs of service providers, dynamic web pages have been widely used. Moreover, most of the services using dynamic web pages have been integrated with databases, such that the services provided by webpages more and more personalized.

Besides, with the gradual popularization of augmented reality (AR) technology, people can combine virtual images with objects or scenes in the real world through display devices so as to provide a real-time interactive experience, which makes the application of AR be diverse, such as product catalogs, learning materials, amusement experiences, exhibition activities, product marketing, etc. All of which can provide people with real-time interactive experience via AR technology.

For product providers, if they want to present physical goods via AR, they usually have to use a professional AR team to photograph a physical product to form a virtual digital image of the product and then the virtual digital image can be presented via AR. However, this method takes a lot of time to manufacture a virtual digital image, such that the product providers cannot perform online marketing for their products via AR.

For consumers, they usually have to download the shopping applications designed for various e-commerce platforms in order to browse the products in these shopping applications via AR. Therefore, the mobile devices of the consumers need to download these shopping applications so as to install these shopping applications on the mobile devices, or the consumers cannot browse the products of these e-commerce platforms via AR.

Accordingly, it has become an important issue to solve the problems for the users and consumers in the application of AR.

### SUMMARY OF THE INVENTION

So as to solve the problems of prior art, the present invention provides an augmented reality (AR) product presentation system, in particular to an AR product presentation system capable of automatically integrating the view angle plane images (the plane images of the product in different view angles), uploaded by a product provider, of a product with each other to generate an AR 3D image, such that a consumer can experience wearing the product via AR and the internet.

One embodiment of the present invention provides an AR product presentation system, which includes a network server, a product information editing module, an AR 3D image generating module, a data storage module and a data processing module. The network server is connected to the electronic device of at least one user and the mobile device of at least one consumer via the internet. The product information editing module is disposed in the network server for the user to edit a product information in order to generate a product browsing webpage. The AR 3D image generating module is disposed in the network server and provided with one or more product view angle setup areas. Each product view angle setup area is for the user to upload one of view angle plane images of a product. The AR 3D image generating module generates an AR 3D product image according to the view angle plane image set by the product view angle setup area. The data storage module is disposed in the network server so as to save the product browsing webpage generated by the product information editing module and the AR 3D product image generated by the AR 3D image generating module. The data processing module is disposed in the network server and electrically connected to the data storage module. The data processing module integrates the product browsing webpage and the AR 3D product image with each other so as to generate a product link information (e.g., an image, a website address or a 2D barcode having hyperlink).

The user can obtain the product link information. The product link information can be directly transmitted to the mobile device of the consumer. Alternatively, the user can publish the product link information by a social network platform via the internet to the mobile device of the consumer. After the consumer receives the product link information, the consumer clicks the product link information so as to open the product browsing webpage. Then, the consumer can directly click the AR 3D product image in the product browsing webpage to execute the AR 3D product image, such that the AR 3D product image is integrated with a target object (e.g., a human body) displayed by the mobile device.

As described above, the technical feature of present invention is: the AR 3D image generating module can integrate the view angle plane images of a product with each other to generate an AR 3D image, and then provides the AR 3D image for a user (e.g., a product provider). Thus, the user only needs to upload one or more of the view angle plane images to the product view angle setup area(s) and then the AR 3D image generating module can generate an AR 3D product image according to the view angle plane image(s) set by one or more of the product view angle setup areas. The present invention can solve the problem that currently available AR technologies take a lot of time to manufacture virtual digital images, and the virtual digital images should be processed and manufactured by a third party.

In addition, the data processing module can integrate the product browsing webpage and the AR 3D product image with each other so as to generate a product link information and the product link information can be transmitted to the mobile device of a consumer. In this way, the consumer can directly click the AR 3D product image to execute the AR 3D product image, such that the AR 3D product image can be integrated with a target object (e.g., a human body) displayed by the mobile device. Therefore, the present invention can solve the problem that the consumer needs to install the shopping application designed for an e-commerce platform on his/her mobile device in order to experience wearing the products of the e-commerce platform via AR.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is the schematic view of the AR product presentation system in accordance with one embodiment of the present invention.

FIG. 2 is the block diagram of the AR product presentation system in accordance with one embodiment of the present invention.

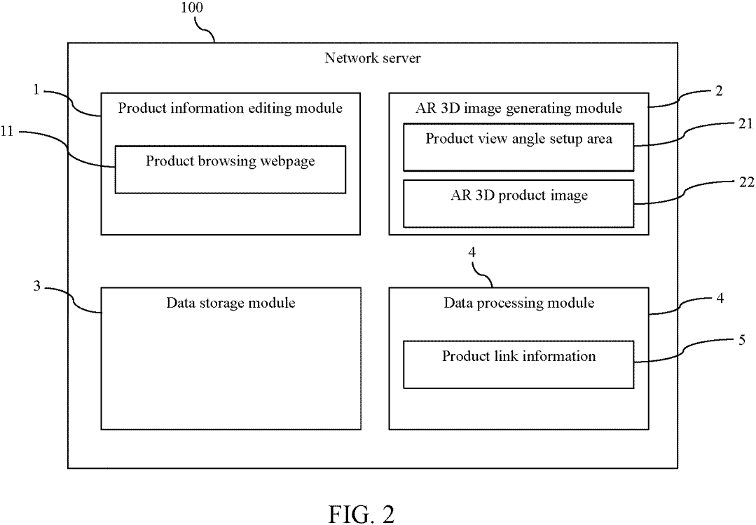

FIG. 3 is the schematic view of the first exemplary embodiment of the AR 3D image generating module of the AR product presentation system in accordance with of the present invention.

FIG. 4 is the schematic view of the second exemplary embodiment of the AR 3D image generating module of the AR product presentation system in accordance with the present invention.

FIG. 5 is the schematic view of the application status of the AR product presentation system in accordance with the first embodiment of the present invention.

FIG. 6 is the schematic view of the application status the AR product presentation system in accordance with the second embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

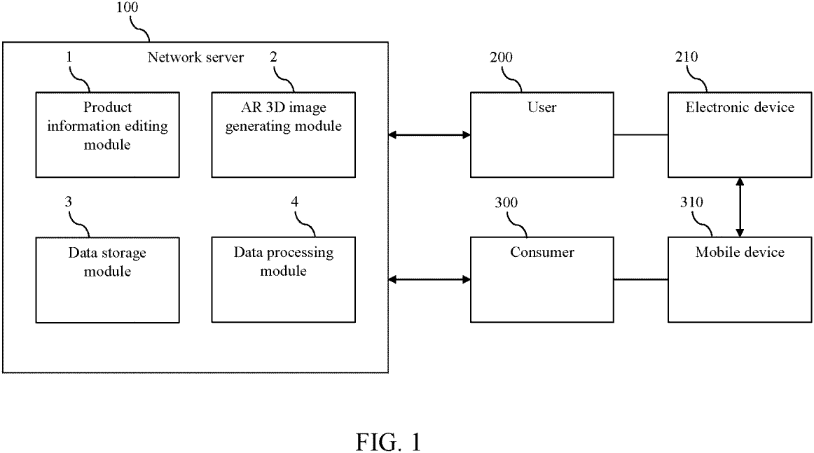

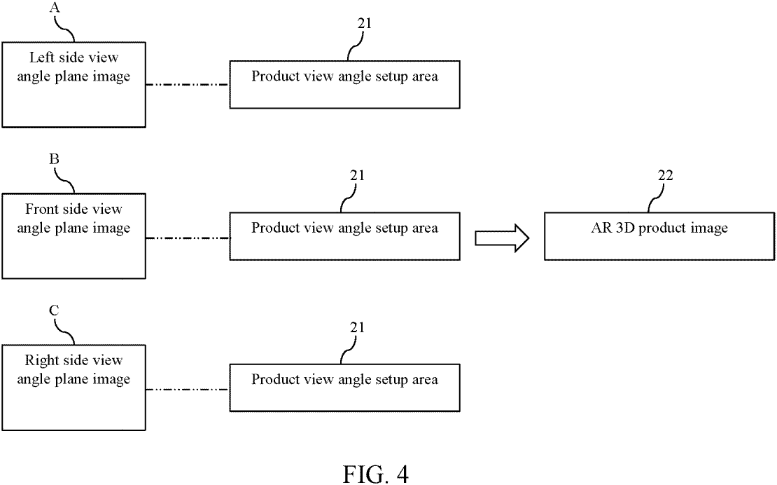

Please refer to FIG. 1~FIG. 4. The embodiment of the present invention discloses an augmented reality (AR) product presentation system, in particular to an AR product presentation system for a consumer to browse the product via a hyperlink and experience wearing the product based on AR via the internet. The product presentation system includes at least one network server 100, a product information editing module 1, an AR 3D image generating module 2, a data storage module 3 and a data processing module 4.

The network server 100 is connected to the electronic device 210 of at least one user (e.g., a product provider) 200 and the mobile device 310 of at least one consumer 300. The electronic device 210 may be a personal computer, a tablet computer, an intelligent communication device or other similar devices. The mobile device 310 may be a personal computer, a tablet computer, an intelligent communication device or other similar devices.

The product information editing module 1 is disposed in the network server 100 and the user can edit the product information via the product information editing module 1 so as to generate a product browsing webpage 11. The product information editing module 1 includes a plurality of default webpage model fields, default images, default text editors and default product display fields for the user 200 to upload a product image via the product information editing module 1 to edit the product image and the text thereof. In this way, the product information editing module 1 can generate the product browsing webpage 11. The product information editing module 1 may be an application (App) installed on the network server 100.

The AR 3D image generating module 2 is disposed in the network server 100. The AR 3D image generating module 2 is provided with one or more product view angle setup areas 21 for the user 200 to upload one of the view angle plane images of a product. Afterward, the AR 3D image generating module 2 generates an AR 3D product image 22 according to the view angle plane image(s) set by the product view angle setup area(s) 21. The AR 3D image generating module 2 may be an application installed on the network server 100.

The data storage module 3 is disposed in the network server 100 with a view to save the product browsing webpage 11 generated by the product information editing module 1 and the AR 3D image 22 generated by the AR 3D image generating module 2. The data storage module 3 further saves the image library of default AR images. Further, the data storage module 3 also saves the data needed by the product information editing module 1 and the AR 3D image generating module 2.

The data processing module 4 is disposed in the network server 100 and electrically connected to the data storage module 3. The data processing module 4 integrates the product browsing webpage 11 and the AR 3D product image 22 with each other so as to generate a product link information 5, and sets the product link information 5 to be a hyperlink connected to the product browsing webpage 11. The product link information 5 is one or a combination of two or more of an image having hyperlink, a website address and a 2D barcode. The data processing module 4 can achieve the hyperlink setting to set the product image in the product browsing webpage 11 to be the hyperlink connected to the finished AR 3D product image. In this way, the AR 3D product image 22 can be displayed after the product image (in the product browsing webpage 11) is clicked.

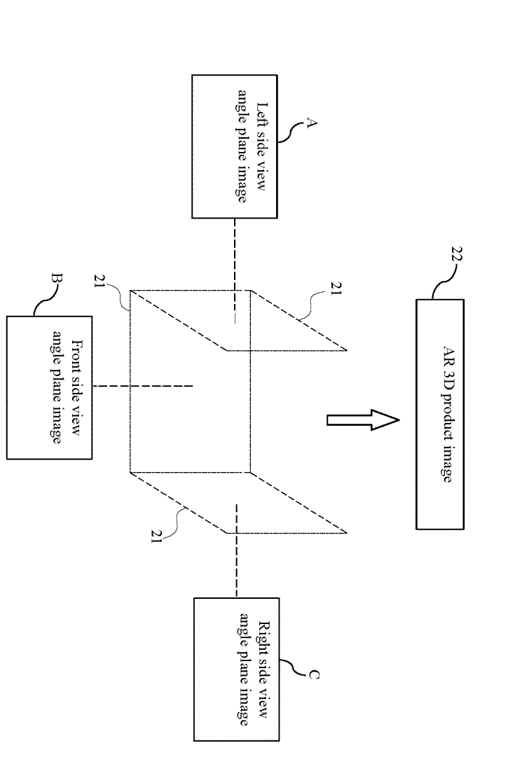

The following provides the first exemplary embodiment for illustrating the operation of the AR 3D image generating module 2 (as shown in FIG. 3). The AR 3D image generating module 2 is provided with one or more product view angle setup areas 21. The product view angle setup area 21 may be a virtual frame. For example, there are three product view angle setup areas 21 (three virtual frames), which are the product view angle setup area 21 of the front view, the product view angle setup area 21 of the left view and the product view angle setup area 21 of the right view. The user 200 can photograph the front view angle plane image B, the left view angle plane image A and the right view angle plane image C of a product first. Then, the user 200 can upload the above images to the product view angle setup areas 21 corresponding thereto. Finally, the AR 3D image generating module 2 can integrate the view angle plane images set by the product view angle setup areas 21 with each other to generate an AR 3D product image 22.

The following provides the second exemplary embodiment for illustrating the operation of the AR 3D image generating module 2 (as shown in FIG. 4). The AR 3D image generating module 2 is provided with one or more product view angle setup areas 21, which can be presented by several fields. For example, there are three product view angle setup areas 21, including the product view angle setup area 21 of the front view angle field, the product view angle setup area 21 of the left view angle field and the product view angle setup area 21 of the right view angle field. The user 200 just needs to photograph the front view angle plane image B, the left view angle plane image B and the right view angle plane image C of a product, and then respectively uploads the above images to the product view angle setup areas 21 corresponding thereto. Then, the AR 3D image generating module 2 can integrate the view angle plane images, of the product, set by the product view angle setup areas 21 with each other with so as to generate an AR 3D product image 22.

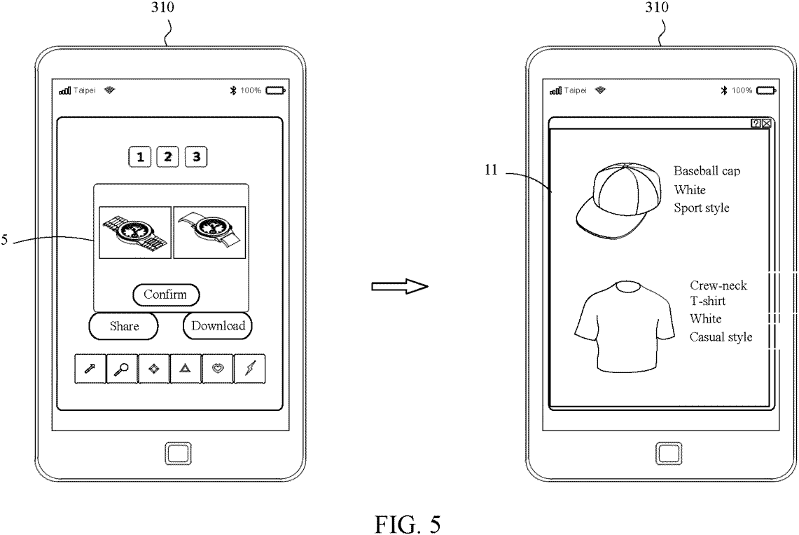

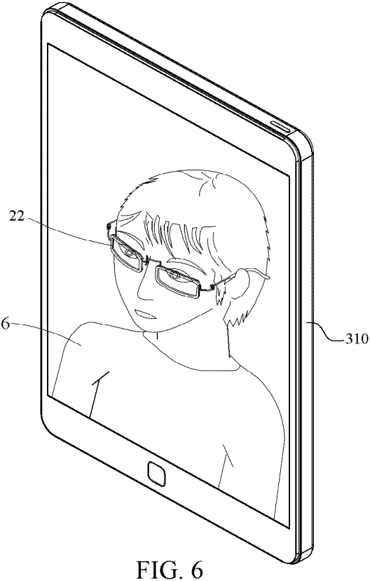

When the data processing module 4 generates a product link information 5, the user 200 can obtain the product link information 5. Then, the user 200 directly transmits the product link information 5 by the electronic device 210 via the internet to the mobile device 310 of the consumer 300. Alternatively, the user 200 can publish the product link information 5 to the mobile device 310 of the consumer 300 by a social network platform or a communication platform (e.g., Facebook, Instagram, Twitter, Line, etc.). When the mobile device 310 of the consumer 300 receives the product link information 5 (as shown in FIG. 5 and FIG. 6), the consumer can click the product link information 5 to connect to the product browsing webpage 11. Afterward, the consumer can directly click any one of the product images in the product browsing webpage 11 to execute the AR 3D product image 21 corresponding thereto, such that the AR 3D product image 21 can be integrated with a target object 6 (e.g., a human body) displayed on the mobile device.

For instance, when the consumer clicks a glasses product image in the product browsing webpage 11, the AR state can be activated. Then, the mobile device 310 of the consumer 300 can photograph the head of the consumer 300 to display the head image on the screen of the mobile device 310. In the meanwhile, the AR 3D product image 22 of the glasses product can be displayed on the two eyes of the consumer 300. In this way, the consumer 300 can experience wearing the virtual glasses product and watch the visual effect thereof via AR and the internet. In addition, in the AR state, the consumer 300 can further click the image library of the default AR images saved in the data storage module 3, such that the consumer 300 can simultaneously add other AR images to the target object 6 when experiencing wearing the virtual glasses product.

The AR 3D product image 22 can be integrated with the target object 6 (e.g., a human body) by the default AR program (engine) of the data processing module 4.

As previously stated, the technical feature of present invention is: the AR 3D image generating module 2 can integrate the view angle plane images of a product with each other to generate an AR 3D image 22, and then provides the AR 3D image 22 for a user 200 (e.g., a product provider). Thus, the user 200 only needs to upload one or more of the view angle plane images to the product view angle setup area(s) 21 and then the AR 3D image generating module 2 can generate an AR 3D product image 22 according to the view angle plane image(s) set by one or more of the product view angle setup areas. The present invention can solve the problem that currently available AR technologies take a lot of time to manufacture virtual digital images, and the virtual digital images should be processed and manufactured by a third party.

Afterward, the data processing module 4 can integrate the product browsing webpage 11 with the AR 3D product image 22 to generate a product link information 5 and transmits the product link information 5 to the mobile device 310 of a consumer 300. Then, the consumer 300 can directly click the AR 3D product image 22 in the product browsing webpage 11 to execute the AR 3D product image 22, such that the AR 3D product image 22 can be integrated with a target object 6 (e.g., a human body) displayed by the mobile device 310. As a result, the present invention can solve the problem that the consumer 300 needs to install the shopping application designed for an e-commerce platform on his/her mobile device 310 in order to experience wearing the products of the e-commerce platform via AR.

Each module (such as the product information editing module 1, the AR 3D image generating module 2, the data storage module 3 and the data processing module 4) of the AR product presentation system according to the embodiments of the present invention may be implemented entirely in hardware, entirely in software or in an implementation containing both hardware and software elements. In embodiments which use software, the software may include, but not limited to, firmware, resident software, microcode, etc. In embodiments which use hardware, the hardware may be implemented within one or more application specific integrated circuits (ASICs), digital signal processors (DSPs), digital signal processing devices (DSPDs), programmable logic devices (PLDs), field programmable gate arrays (FPGAs), central-processing unit (CPU), controllers, micro-controllers, microprocessors, electronic devices, other electronic units designed to perform the functions described herein, or a combination thereof.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An augmented reality (AR) product presentation system for consumers to experience wearing products based on AR via network, comprising:
at least one network server connected to an electronic device of at least one user and a mobile device of at least one consumer via an internet;
a product information editing module disposed in the network server for the user to edit a product information in order to generate a product browsing webpage;
an AR three-dimensional (3D) image generating module disposed in the network server and provided with at least one product view angle setup area for the user to upload one of view angle plane images of a product, wherein the AR 3D image generating module is configured to generate an AR 3D product image according to the view angle plane image set by the product view angle setup area;
a data storage module disposed in the network server and configured to save the product browsing webpage generated by the product information editing module and the AR 3D product image generated by the AR 3D image generating module; and
a data processing module disposed in the network server and electrically connected to the data storage module, and configured to integrate the product browsing webpage and the AR 3D product image with each other so as to generate a product link information, and set the product link information to be a hyperlink connected to the product browsing webpage;
wherein the product link information is transmitted to the mobile device of the consumer via the internet for the consumer to click the product link information in order to open the product browsing webpage, and the consumer clicks the AR 3D product image in the product browsing webpage to execute the AR 3D product image, such that the AR 3D product image is integrated with a target object displayed by the mobile device.

2. The AR product presentation system as claimed in claim 1, wherein the product information editing module includes a plurality of default webpage model fields, default images, default text editors and default product display fields for the user to upload a product image via the product information editing module to edit the product image and a text thereof, such that the product information editing module generates the product browsing webpage.

3. The AR product presentation system as claimed in claim 1, wherein the product view angle setup area is a virtual frame.

4. The AR product presentation system as claimed in claim 1, wherein the product view angle setup area includes one or more fields.

5. The AR product presentation system as claimed in claim 1, wherein the data storage module further saves an image library of default AR images.

6. The AR product presentation system as claimed in claim 1, wherein the product link information is one or a combination of two or more of an image having hyperlink, a website address and a two-dimensional (2D) barcode.

7. The AR product presentation system as claimed in claim 1, wherein the user directly transmits the product link information to the mobile device of the consumer via the internet after the user obtains the product link information.

8. The AR product presentation system as claimed in claim 1, wherein the user publishes the product link information by a social network platform or a communication platform via the internet to the mobile device of the consumer after the user obtains the product link information.
